(19) United States
(12) Patent Application Publication
(10) Pub. No.: US 2010/0318982 A1
(43) Pub. Date: Dec. 16, 2010

(54) UPDATING ELECTRONIC DOCUMENTS

(75) Inventors: John William Lumley, Bristol (GB); Robert Thomas Owen Rees, Newport (GB); Steven Andrew Battle, Bristol (GB)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/482,646

(22) Filed: Jun. 11, 2009

(51) Int. Cl. G06F 9/44

(52) U.S. Cl. 717/168; 707/609

(57) ABSTRACT

A method for updating electronic documents includes associating at least one update program with the electronic document such that, in response to specific stimuli, the at least one update program is executed to operate on content of the electronic document.

### BACKGROUND

Electronic documents are typically stored as digital data. More specifically, a standard electronic document is a set of digital data including parameters that determine what will be displayed and how when the document is rendered for a display device or for printing. This digital data is stored in a format which allows various systems to read that data and render it to be displayed or printed. An active electronic document is one that can be changed or updated dynamically. Active documents are typically employed when the document is intended to be updated regularly.

An active document needs to respond to external stimuli in order to change its state or to be updated. The programming for such behavior is typically written in the software toolkit that opens or operates that specific type of document. The active document itself contains data structures designed to be manipulated by the document's corresponding software. The active document's corresponding software keeps track of any policies or constraints the document may have.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustrative diagram depicting how active documents are typically updated, according to principles described herein.

FIG. 2 is an illustrative diagram depicting how active electronic documents can be updated by embedding update programs inside the document itself, according to one embodiment of principles described herein.

FIG. 3 is an illustrative diagram depicting the updating process when update programs are embedded within an active electronic document, according to one embodiment of principles described herein.

FIG. 4 is an illustrative diagram depicting an exemplary active electronic document which may use embedded update programs, according to one embodiment of principles described herein.

FIG. 5 is an illustrative flow chart describing an exemplary process for updating active electronic documents with embedded update programs, according to one embodiment of principles described herein.

Throughout the drawings, identical reference numbers designate similar, but not necessarily identical, elements.

### DETAILED DESCRIPTION

As mentioned above, the programming required for updating active electronic documents is typically part of the software designed for reading and manipulating specific types of active documents. However, this arrangement does not allow much versatility or adaptability. Active electronic documents can be designed for a variety of purposes, and a corresponding piece of manipulating software must be designed as well. This can create quite a complex scenario as new documents and new states for those documents are designed and implemented.

Some current document formats contain macros which are able to update or change the state of the document. However, these macros are triggered through internal operations as opposed to external operations. Internal operations would include the user entering a specific value into a certain field in the document.

Object oriented programming uses variables and methods defined within a class to create objects based on those classes. These principles apply to objects for computer application design and not to documents themselves.

The present specification relates to a method of embedding programs and methods for updating active electronic documents within the documents themselves, i.e., within the data set or file that can be rendered to produce the document. When external stimuli prompt the document for update, the document will conditionally produce a new version of itself based on the proffered stimuli. The updating programs embedded in the document can have a set of policies and constraints which may describe and limit the circumstances or conditions under which the document may be updated.

An active document embodying principles described herein will be able to update itself and the corresponding software for opening or manipulating that document will need only a generic way of interacting with the document. With this, the active documents using this system will be highly flexible and adaptable to various purposes.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Herein and in the appended claims, an active electronic document embodying principles of the innovation described in the present specification will be referred to as a “self-updating document,” or a “self-updating active document.” A self-updating document will refer to an electronic document which has updating programs embedded within the document itself able to respond to external stimuli by producing a new and updated version of the document. The term “updating programs” will refer to those programs which are embedded into the self-updating documents that may contain methods, policies, constraints, and other content to be used by the updating process. The term “corresponding software” will refer to any software application or toolkit which opens, reads, manipulates, renders, or operates an active electronic document with or without embedded update programs. The corresponding software may be, for example, a word processor, desktop publishing application or the like.

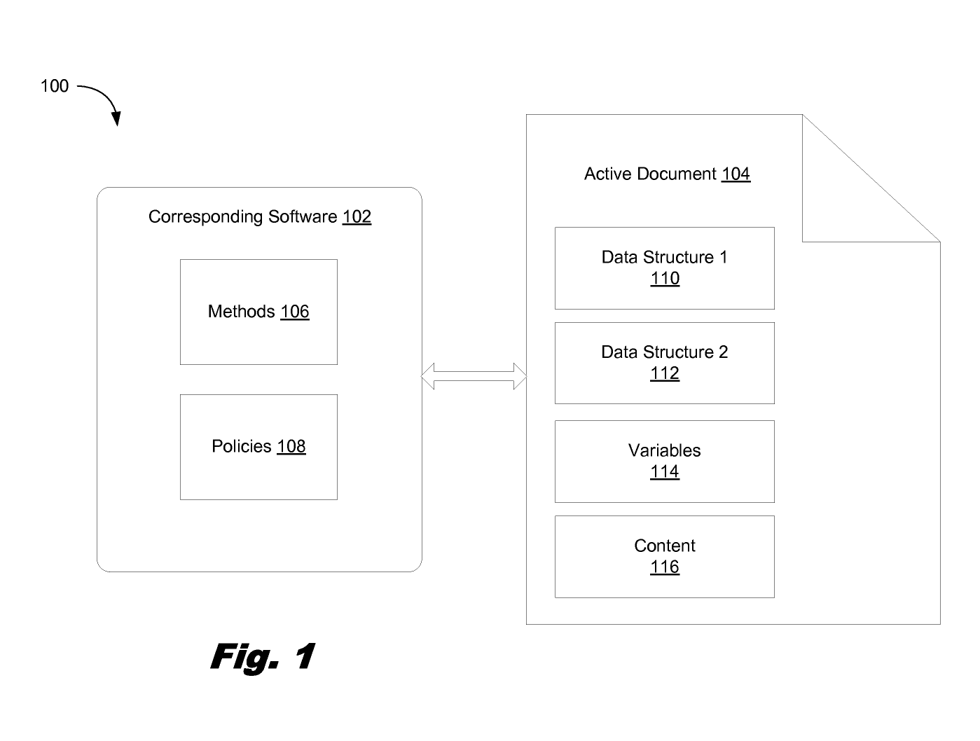

FIG. 1 is an illustrative diagram (100) depicting how active documents (104) are typically updated. As mentioned above, active documents (104) typically rely on a piece of corresponding software (102) for manipulation. The corresponding software (102) will typically contain methods (106) and policies (108) for interaction with the associated active document (104). A method (106) may be defined as a set of instructions for operating on content within the document. A policy (108) may dictate conditions under which certain methods may be performed. The active document (104) itself may contain data structures (110,112) and other variables (114) along with the primary content (116). The primary content of the document refers to the material and elements in the document that fulfill the purposes for which the document was created.

This setup is quite limited as the same methods (106) and policies (108) within the corresponding software (102) apply to all documents that are configured or able to interact with the corresponding software (102). If different methods (106) or policies (108) are needed for different documents, the corresponding software (102) must be changed to accommodate those new methods (106) and policies (108). For example, assume the corresponding software (102) initially has a policy (108) to not allow a certain data type. Consequently, data structure 1 (110) of the document (104) initially does not include that forbidden data type. However, if it becomes desired for the active document (104) to include that data type, the policies (108) must be updated in the corresponding software (102) to handle the new data type. In a further example, if a method for operating on the information in data structure 2 (112) is not included in the methods (106) of the corresponding software (102), the methods (106) in the corresponding software (102) must be updated before handling the active document (104).

Active documents (104) can be designed to be in different states. In a simple example, the document may be in a complete state or an incomplete state. An incomplete document may be used, for example, as a form needing to be filled out by a user.

Sometimes a variable (114) inside the document is used to determine its state. In some cases, the primary content (116) of the document can change based on its state.

The methods (106) for altering the state of a document, including updating document variables (114), may be contained in the corresponding software (102). However, this is limiting because slight variations in different documents may require new methods to operate on them and indicate a change of document state.

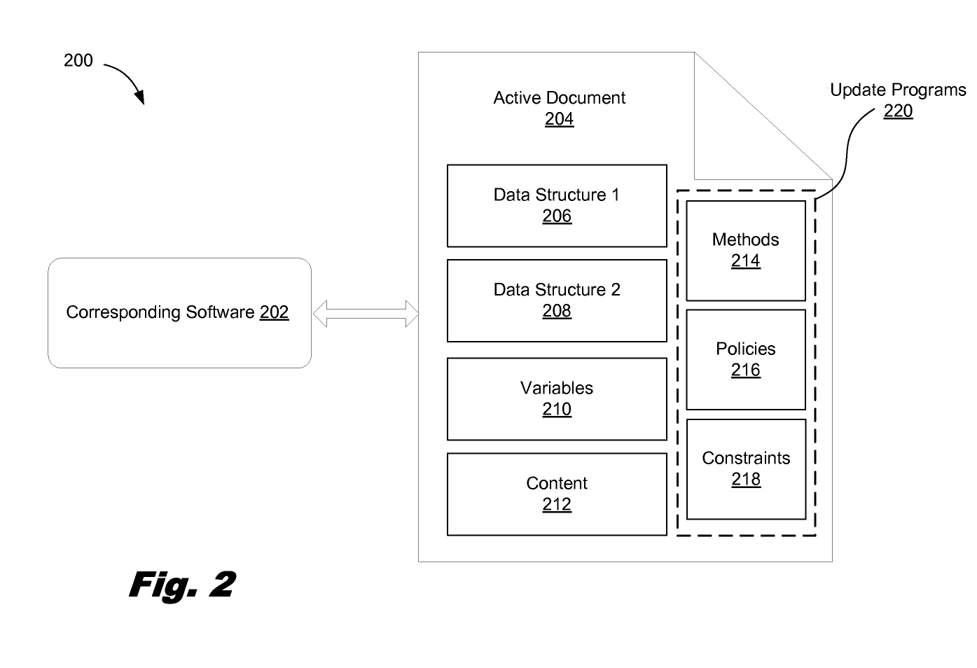

FIG. 2 is an illustrative diagram (200) depicting how an active electronic document (204) can be updated using embedded programs (220) inside the document (204) itself. As mentioned above, this will allow the corresponding software (202) to contain only a simplified or generic way to view or operate the active document (204). With the methods (214) and policies (216) being associated with an embedded update program (220), the active document (204) will be able to update itself in ways specific to either the document type or even the document instance without relying on external procedural instructions.

With embedded update programs (220) within the active document (204) itself, methods (214) and policies (216) can be designed specifically for the intended use of the active document (204). For example, methods (214) which have been designed to operate on the specific types of information stored in data structure 1 (206) can be designed for a specific document and embedded therein. Likewise, policies (216) regarding the information in data structure 2 (208) may be defined for a specific document and then embedded therein.

As mentioned above, active documents are able to alter their state. With the update programs embedded into the active document (204) itself, the document (204) will be able to change its state through various operations or stimuli both external and internal to the document. The exact content (212) to change according to different states of the document may be determined by the embedded update programs (220).

In one embodiment, an active document (204) may be embedded with multiple update programs (220) each updating various aspects of the document (204). These multiple programs can be executed in any of a variety of different orders based on policies (216) also embedded within the document (204).

Various constraints (218) may also be put in place to limit when and under what conditions the document (220) may be changed or updated. A constraint may be defined as a limit or specification of various conditions under which certain actions within the update programs may occur.

In one illustrative embodiment, a constraint (218) could be based on the current time or date. The update programs (220) within the document can be set to only allow certain changes to the document during certain times of the day or only on, after or prior to a specific date. The update programs (220) can be set to alter the state of the document at various times or dates. A different set of methods (214), policies (216) and constraints (218) may be used depending on the state in which the document (204) currently is.

The exact structure and content of an active document (204) with embedded update programs (220) is not limited to the one described in this figure. There may be many different varieties of document types containing different material with various types of embedded update programs (220) designed for specific types of content.

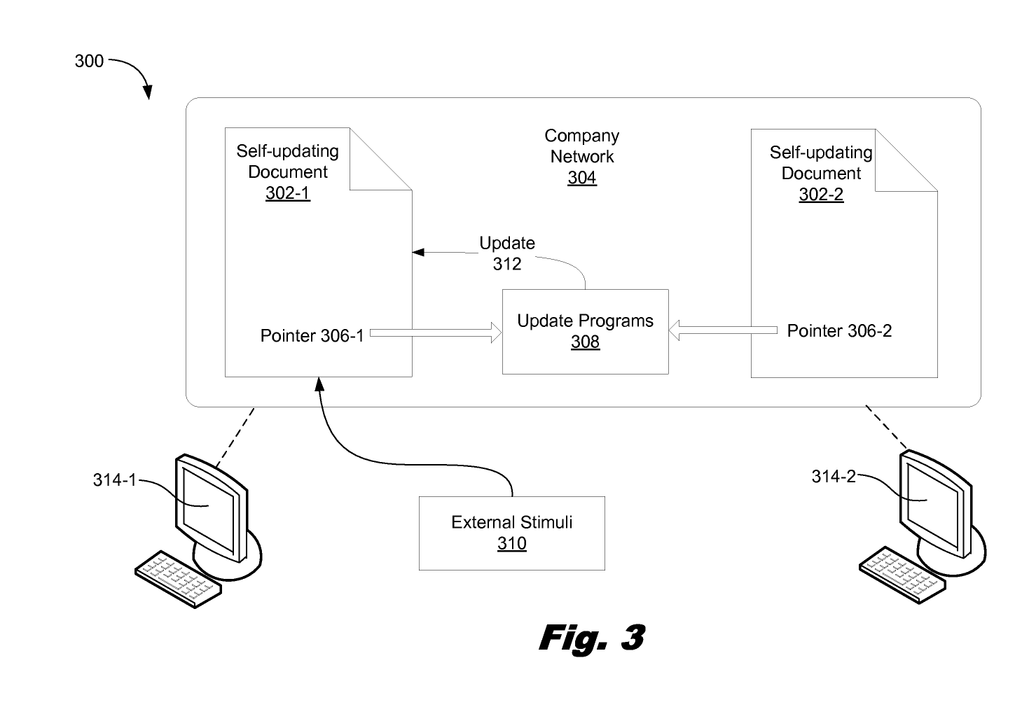

FIG. 3 is an illustrative diagram (300) depicting the updating process when update programs (308) are embedded within an active electronic document (302-1,302-2). In one embodiment, the self-updating documents (302-1,302-2) may be stored on a company network (304).

Often times, many instances of a document will exist. For example, a self-updating document (302-1,302-2) may be a form document for employee information in a company. In this case, there will be several instances of that document (302-1,302-2), possibly one for each employee. In this case, to save electronic storage space, the embedded update programs (308) could be shared by all instances of the document. Each document (302-1,302-2) could contain a pointer (306-1,306-2) that would reference a shared file containing the update programs (308). It will be readily apparent to those familiar with the relevant art that this dynamic linking method will allow the active document (302-1,302-2) to appear to the corresponding software (202) as though the referenced update programs (308) are actually part of the self-updating document (302-1,302-2).

As mentioned above, the document can be updated based on various external stimuli (310). When these various stimuli (310) are proffered to the self-updating documents (302-1,302-2), the various embedded update programs (308) will check their methods (214, FIG. 2), policies (216, FIG. 2), and constraints (218, FIG. 2) and update (312) the document accordingly.

External stimuli (310) may come from a variety of sources including for example, workstations (314-1,314-2) on the company network. A user may access the self-updating document (302-1,302-2) from a workstation (314-1,314-2) and attempt to change certain variables. If the user attempts to update something that the embedded policies (216, FIG. 2) dictate should not be rewritten, the embedded update programs (308) may ignore the request or return an error signal.

There may be many different methods of embedding update programs into an active electronic document (302-1,302-2). In one embodiment, there could be an electronic document template with the update programs (308) relevant to the specific document type already embedded. In this case, the corresponding software (202, FIG. 2) would create documents with as many updating programs as needed already embedded. Any update process may be triggered from a workstation (314-1,314-2) or other external stimuli (310) and will proceed as directed by the embedded update programs (308).

In one embodiment, update programs (308) could be embedded into an already existing active electronic document (302-1,302-2). If a document has been created without an existing template containing embedded update programs (308), it may be possible to embed them in an already created document at any time after the document's creation.

There may be many programming methods to embed self-updating programs (308) within an active electronic document (302-1,302-2). In one embodiment, XML (Extensible Markup Language) could be used to represent the content, variables, methods (214, FIG. 2) and policies (216, FIG. 2) involved with the active documents (302-1,302-2). XML is a widely used technology and can be used by many different systems. The updating process (312) can be designed using an XML toolkit. The self-updating programs (308) embedded within the active electronic documents (302-1,302-2) may use XSLT (Extensible Stylesheet Language Transformations) transforms to describe any transformations that may take place during the update process (312).

The system shown in FIG. 3 can also be used to create the self-updating documents (320). For example, any of the workstations (314) can be used to produce the document (320) as well as to either embed specific update programs (308) in a document (320) or to add the pointers (306) to a document that will locate the desired update programs (308). As will be appreciated by those skilled in the art, many other systems may also be used to create or manage the self-updating documents (320) described herein.

For example, a system for updating electronic documents may include a workstation (314) that is configured for associating at least one update program (308) with an electronic document such (320) that, in response to specific stimuli, the at least one update program is executed to operate on content of the electronic document. The workstation (314) may be configured for selectively embedding the at least one update program in the electronic document and/or for selectively inserting a pointer in the electronic document to the at least one update program. As indicated above, the update program may contain methods, policies, and constraints for operating and updating various content, variables and data structures within the electronic document.

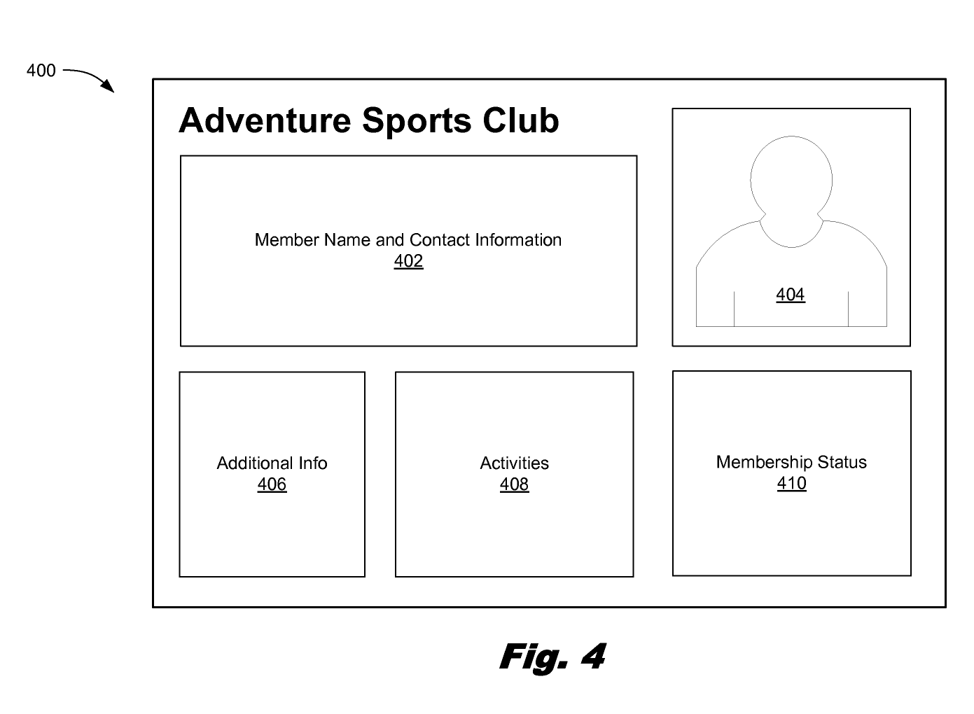

FIG. 4 is an illustrative diagram depicting an exemplary active electronic document (400) which may use embedded update programs (308, FIG. 3). In various embodiments, the electronic document is stored on a physical medium for storing computer-readable instructions, for example, but not limited to, a hard disk drive, Flash memory, disk array or other computer memory. As indicated herein, the document includes at least one update program that, in response to specific stimuli, is executed to operate on content of said electronic document. The at least one update program associated with said electronic document may be embedded in said electronic document.

As indicated above, the electronic document may be in one of several states indicated by a variable stored in said electronic document. The at least one update program invokes a different set of methods, policies, and constraints depending on the state of said electronic document.

Referring specifically to FIG. 4, in one illustrative embodiment, an active electronic document (400) could be a member information form for an adventure sports club. The active document (400) could contain basic member contact information (402), a picture of the member (404), additional relevant information about the member (406), activities (408) with which the member is involved, and membership status (410).

It may be the case that the adventure sports club only allows a member to be involved with a certain amount of activities (408) at a time based on current membership status. If, for example, the data structure (206, FIG. 2) holding the activity (408) information has a cardinality of 2, the embedded update programs (220, FIG. 2) can keep track of the limit on activities (408) and what the exact replacement policy for adding new activities (408) should be.

These policies (216, FIG. 2) and constraints (218, FIG. 2) can be localized within the document (400) so when an external stimuli such as additional information to be updated is sent to the document, the update programs (220, FIG. 2) embedded in the document have all the methods (214, FIG. 2) and policies (216, FIG. 2) necessary to complete the update process. For example, the document may refuse to accept additional data to the list of associated activities if the number already listed equals the maximum allowed for that club member.

It may also be that the number of activities (408) with which a member is able to be involved will change based on membership status (410). In this case, the embedded update programs (220, FIG. 2) may also contain the necessary policies (216, FIG. 2) and constraints (218, FIG. 2) for the varying membership status (410) conditions. If a member reaches a higher club status, the size of the data structure (206, FIG. 2) holding the associated activities may increase.

To illustrate further possible embodiments, it may be possible to have constraints (218, FIG. 2) that limit the amount of times an update can take place. For example, a member may wish to occasionally change their profile picture (404). A policy within the embedded update programs may limit the amount of times a member may do so. It may be that a member can only update the profile picture (404) once a year.

A further constraint may be that specific variables (210, FIG. 2) within the document may only be written once. For example, there may be certain additional information (406) about members that only club administrators are able to see. It may be policy that once this information is written, it can not be rewritten. Again, these types of policies (216, FIG. 2) can be associated with the embedded update programs (220, FIG. 2) in the document. The embedded update programs (220, FIG. 2) can keep track of the status of certain variables (210, FIG. 2); once those variables have been assigned any alteration is disallowed.

By embedding the methods (214, FIG. 2), policies (216, FIG. 2), and constraints (218, FIG. 2) within a document itself, several different customized documents can be viewed and operated by a single generic piece of corresponding software (202, FIG. 2). The corresponding software (202, FIG. 2) need not be concerned with the many details of each type of document's updating policies (216, FIG. 2).

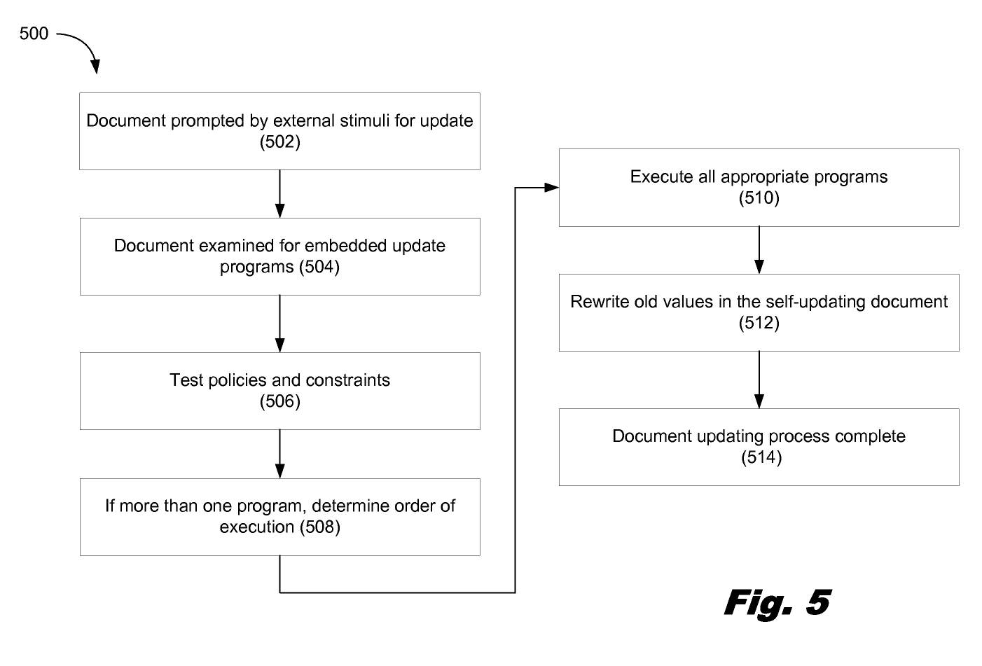

FIG. 5 is a flow chart (500) describing an illustrative process for updating active electronic documents when update programs are embedded therein. The process described below is merely an example of one method of updating documents with embedded programs. Any method for updating documents employing principles described in the present specification may be used.

First, a self-updating document must be prompted by some external stimuli indicating that an update needs to take place (502). This may be done through a variety of methods.

The self-updating document will then be examined for any embedded update programs (504). The document may contain any number of such programs.

Any policies (216, FIG. 2) or constraints (218, FIG. 2) will then need to be examined (506). The data presented for update may need to be matched against various criteria contained within the policies (216, FIG. 2) and constraints (218, FIG. 2). The policies (216, FIG. 2) may determine the order of execution, if there is more than one update program embedded (508).

All programs given permission to be executed will then be executed (510). All appropriate values in the self-updating document will then be rewritten (512) in response to the incoming stimuli. The document updating process will then be complete (514).

In sum, an active electronic document (204, FIG. 2) is embedded with one or more update programs (220, FIG. 2) which respond to external stimuli. Upon execution of these embedded update programs (220, FIG. 2), specified variables (210, FIG. 2) are rewritten or updated based on methods (214, FIG. 2), policies (216, FIG. 2), and constraints (218, FIG. 2) associated with the embedded update programs.

A piece of corresponding software (202, FIG. 2) will need only a generic way to read different types of documents, without being concerned for document specific methods (214, FIG. 2), policies (216, FIG. 2), and constraints (218, FIG. 2). A highly flexible and adaptable active electronic document (204, FIG. 2) is able to be customized for a variety of purposes and still be operated by the same piece of corresponding software (202, FIG. 2).

An electronic document embodying principles described in this specification can localize both the state and behavior of the document in a single place. This allows editing to be done at a single place within the document itself without any editing done to the corresponding software.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for updating electronic documents, the method comprising
associating at least one update program with an electronic document such that, in response to specific stimuli, said at least one update program is executed to operate on content of said electronic document.

2. The method of claim 1, further comprising embedding said at least one update program in said electronic document.

3. The method of claim 1, further comprising inserting a pointer in said electronic document to said at least one update program.

4. The method of claim 1, in which said at least one update program contain methods, policies, and constraints for operating and updating various content, variables and data structures within said electronic document.

5. The method of claim 4, in which said electronic document is in one of several states indicated by a variable stored in said electronic document.

6. The method of claim 5, in which a different set of said methods, policies, and constraints is used depending on the state of said electronic document.

7. The method of claim 1, in which said specific stimuli comprises user input.

8. The method of claim 1, in which said at least on update program comprises a plurality of update programs which are executed in a particular order.

9. The method of claim 8, further comprising determining the order in which said update programs are executed based on policies in said electronic document.

10. A system for updating electronic documents, the system comprising a workstation configured for associating at least one update program with an electronic document such that, in response to specific stimuli, said at least one update program is executed to operate on content of said electronic document.

11. The system of claim 10, in which said workstation is configured for selectively embedding said at least one update program in said electronic document and for selectively inserting a pointer in said electronic document to said at least one update program.

12. The system of claim 10, in which said at least one update program contain methods, policies, and constraints for operating and updating various content, variables and data structures within said electronic document.

13. A method for updating electronic documents, the method comprising
embedding at least one update program or a link to an update program within the data of an electronic document such that, in response to specific stimuli, said at least one update program is executed to operate on content of said electronic document;
such that said at least one update program is executed in response to occurrence of specified stimuli to update said electronic document;
in which said at least one update program contain methods, policies, and constraints for operating and updating various content, variables and data structures within said electronic document.

14. The method of claim 13, in which said electronic document is in one of several states indicated by a variable stored in said electronic document.

15. The method of claim 14, in which a different set of said methods, policies, and constraints is used depending on the state of said electronic document.
